(19) United States
(12) Patent Application Publication
(10) Pub. No.: US 2025/0029085 A1
(43) Pub. Date: Jan. 23, 2025

(54) IMAGE-BASED MULTI-USER TRANSACTION AUTHENTICATION AND ALLOCATION

(71) Applicant: Wells Fargo Bank, N.A., San Francisco, CA (US)

(72) Inventors: Biswajit Mishra, Bengaluru (IN); Bhawana Chauhan, Bengaluru (IN); Durga Vijay Kumar Sunkavalli, Hyderabad (IN)

(21) Appl. No.: 17/655,068

(22) Filed: Mar. 16, 2022

(51) Int. Cl. G06Q 20/22; G06Q 20/40; G06V 40/16; G06V 40/20

(52) U.S. Cl. CPC G06Q 20/22; G06Q 20/4014; G06V 40/172; G06V 40/28

(57) ABSTRACT

Computer-implemented methods, apparatuses, and computer program products are provided for multi-user transaction authentication and allocation. An example computer-implemented method includes receiving a transaction payment request data object from a first user device that includes image data and a transaction payment request value. The method further includes determining a first user and a second user from amongst the plurality of users based at least in part upon the image data, determining a first sub-transaction value for the first user, and determining a second sub-transaction value for the second user. The method further includes generating a responsive transaction payment data object that includes instructions for executing a transaction responsive to the transaction payment request data object.

### TECHNOLOGICAL FIELD

Example embodiments of the present disclosure relate generally to transaction management and, more particularly, to image-based techniques for multi-user authentication and allocation.

### BACKGROUND

Users often rely upon a number of mechanisms for effectuating transactions with other users as well as with the entities (e.g., businesses, merchants, vendors, etc.) with which they interact. Additionally, in some instances, users may attempt to leverage some of the functionality provided by associated user devices to facilitate these transactions. As the number of users and user devices associated with a transaction increases, the management (e.g., authentication, allocation, etc.) of the transaction becomes increasingly challenging due to the substantial computational burden required to account for these distinct users and devices.

### BRIEF SUMMARY

As described above, users often rely upon a number of mechanisms for effectuating transactions with other users as well as with the entities (e.g., businesses, merchants, vendors, etc.) with which they interact and may further attempt to leverage some of the functionality provided by associated user devices to facilitate these transactions. As the number of users associated with a transaction increases, however, performing transaction management operations with respect to the transaction becomes more computationally challenging using traditional transaction management frameworks. For example, the performance of transaction management across a plurality of users may require operations associated with determining the users, authenticating the users, and/or allocating a transaction payment request value across the users. In addition to these computational burdens, the inability of conventional systems to provide a streamlined approach to these transactions results in constant burden on the associated users, such as by requiring each user to individually provide user credentials, payment parameters, account details, etc. to complete a transaction.

To address these challenges and others, various embodiments of the present disclosure introduce techniques for generating a responsive transaction payment detect object. In some embodiments, a responsive transaction payment data object includes instructions for executing a transaction responsive to the transaction payment request data object, where the instructions are determined based on a first sub-transaction value for a first user and a second sub-transaction value for a second user. In some embodiments, generating the responsive transaction payment data object includes receiving a transaction payment request data object from a first user device where the transaction payment request data object includes image data generated by the first user device indicative of a plurality of users, and a transaction payment request value. This process may further include determining a first user from amongst the plurality of users based at least in part upon the image data and determining a second user from amongst the plurality of users based at least in part upon the image data. This process may further include determining a first sub-transaction value for the first user where the first sub-transaction value for the first user defines a first portion of the transaction payment request value of the transaction payment request data object and determining a second sub-transaction value for the second user where the second sub-transaction value for the second user defines a second portion of the transaction payment request value of the transaction payment request data object. The process may further include generating a responsive transaction payment data object that includes instructions for executing a transaction responsive to the transaction payment request data object.

In some embodiments, the first transaction sub-value and the second transaction value may be determined based on image metadata describing one or more identifying characteristics of at least one of the first user, second user, or first user device. As described in greater detail below, in some embodiments, the image metadata of the transaction payment request data object may be used to identify the users associated with the transaction payment request data object. In some embodiments, the image metadata of the transaction payment request data object may be used to authenticate at least one of the users associated with the transaction payment request data object. In some embodiments, the image metadata of the transaction payment request data object may be used to determine a sub-transaction amount for the users associated with the transaction payment request data object. In some embodiments the image metadata of the transaction payment request data object may be used to determine a sub-transaction value for at least one of the users associated with the transaction payment request data object. In some embodiments, the one or more identifying characteristics may be indicative of a transaction allocation between the transaction payment request value and at least one of the first sub-transaction value or second sub-transaction value.

In some embodiments, a comparison between the one or more identifying characteristics from the image data or image metadata and one or more authentication characteristics stored in a corresponding user profile may be used to authenticate the first user and/or the second user. For example, in some embodiments, the one or more authenticating characteristics of a particular user, as described by the corresponding user profile of the user, may describe one or more facial expressions/gestures associated with the particular user. In some of the noted embodiments, image data associated with a facial region of the particular user may be processed by a facial expression detection machine learning model to detect an identifying characteristic describing an inferred facial expression of the particular user. In some of the noted embodiments, if the inferred facial expression of the particular user matches an authenticating facial expression of the particular user as described by the authenticating characteristics of the user, then the user may be authenticated. Otherwise, if the inferred facial expression of the particular user fails to match the authenticating facial expression of the particular user as described by the authenticating characteristics of the user, then the user may not be authenticated.

In some embodiments, the first sub-transaction value and the second sub-transaction value may be the same. For example, if the transaction payment request value for the transaction payment request data object is $180.00, and if the transaction payment request data object is associated with three users, then each user may be allocated a sub-transaction value of $60.00.

In some embodiments, the image data may be generated by a first imaging device of the first user device, and the first user and the second user may be commonly located within an image frame included in the image data. In some embodiments, the image data may include first image data generated by a first imaging device of the first user device at a first time that includes the first user, and second image data generated by a second imaging device of the first user device at the first time that includes the second user.

In some embodiments, the responsive transaction payment data object is generated based on one or more supplementary user data objects. In some embodiments, the one or more supplementary user data objects may be associated with the transaction payment request data object. In some embodiments, the one or more supplementary user data objects may include image data depicting one or more additional users. In some embodiments, the one or more one or more supplementary user data objects may be received from one or more additional user devices.

In some embodiments, the techniques described herein for performing multi-party transaction management may be used to facilitate operations of a payment authentication system (PAS) for payment transactions using single authentication as an alternative to one-time passwords (OTPs) or the like. The PAS may authenticate a payer and payee using authentication information as received from one or more user devices by comparing the received authentication information to predetermined authentication data. Authentication information may include a facial image, facial gesture, and/or video of the individual. The PAS may automatically retrieve account details of the payer and payee and perform the financial transaction by debiting a default payer account and crediting a default account of the payee in an instance in which the payer and payee are authenticated.

For example, in some embodiments, the PAS may receive a transaction request from a payer or payee and activate one or more sensors of a user device associated with the requesting user (e.g., payer or payee) to capture authentication data (e.g., facial image, facial gesture, video, etc.) of the payer and/or payee. The PAS may compare the captured authentication data to predetermined authentication data, such as facial image data corresponding to the requesting user's profile to authenticate the transaction request. In an instance in which the transaction request is successfully authenticated, the PAS may retrieve account details of the requesting user and perform the financial transaction. In some instances, the sensors may simultaneously capture images and/or video of the payer and the payee, such as via a front facing camera and a rear facing camera of a user's device.

The PAS may additionally or alternatively capture authentication data of a group of individuals, including one or more payers and the payee, in response to the transaction request. The PAS may then authenticate the group of payers and/or the payee by comparing the captured authentication data to predetermined authenticated data, such as facial image data corresponding to each payer's profile to authenticate the transaction request. In some embodiments, the group of individuals may be required to exist in a common reference frame (e.g., a group photo) with different users required to provide different positions, expressions, etc. for authentication and/or modifications of the same in response to instructions by an associated device. When the transaction request is successfully authenticated, the PAS may retrieve account details of the group of payers and payee and perform the financial transaction by debiting a shared amount from the default accounts of the group of payers and crediting a total shared amount of each of the group of payers to the default account of the payee.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates a system diagram including devices that may be involved in some example embodiments described herein.

FIG. 2 provides an example predictive data analysis computing entity in accordance with some embodiments discussed herein.

FIG. 3 provides an example computing entity in accordance with some embodiments discussed herein.

FIG. 4 illustrates an example flowchart for image-based transaction authentication and allocation across a plurality of users, in accordance with some example embodiments described herein.

FIG. 5 illustrates an example flowchart for determining a sub-transaction value for a particular user, in accordance with some example embodiments described herein.

FIG. 6 illustrates an operational example of an image associated with a transaction payment request data object, in accordance with some example embodiments described herein.

FIG. 7 illustrates an operational example of a user notification that is generated based on a responsive transaction payment data object, in accordance with some example embodiments described herein.

### DETAILED DESCRIPTION

Some embodiments of the present disclosure will now be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout. As used herein, the description may refer to a predictive data analysis system as an example “apparatus.” However, elements of the apparatus described herein may be equally applicable to the claimed method and computer program product. Thus, use of any such terms should not be taken to limit the spirit and scope of embodiments of the present disclosure.

### Definition of Certain Terms

As used herein, the terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the word “example” is used to mean “serving as an example, instance, or illustration.” Any implementation described herein as “example” is not necessarily to be construed as preferred or advantageous over other implementations.

As used herein, the terms “user device,” “mobile device,” “electronic device” and the like refer to computer hardware that is configured (either physically or by the execution of software) to access one or more services made available by a predictive data analysis system (e.g., apparatus or computing device of the present disclosure) and, among various other functions, is configured to directly, or indirectly, transmit and receive data. Example user devices may include a smartphone, a tablet computer, a laptop computer, a wearable device (e.g., smart glasses, smart watch, or the like), and the like. In some embodiments, a user device may include a “smart device” that is equipped with a chip or other electronic device that is configured to communicate with the apparatus via Bluetooth, NFC, Wi-Fi, 3G, 4G, 5G, RFID protocols, and the like. By way of a particular example, a user device may be a mobile phone equipped with a Wi-Fi radio that is configured to communicate with a Wi-Fi access point that is in communication with the predictive data analysis system 101 or other computing devices via a network.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

As used herein, the term “first user device” refers to a user device as defined above that is associated with a first user which may be in network communication with the predictive data analysis system and designated user devices. For example, a first user device may be a computing device of a first user that may request, receive, and/or provide data to or from one of the devices described above. By way of a particular example, a first user device may be a mobile device associated with a first user and used to, in whole or in part, complete a service for the first user. Furthermore, a first user device and associated first user may include a first user profile. Such a first user profile may refer to electronically managed data representing the first user within a computing environment and may include data that embodies and/or uniquely identifies a user within the computing environment. In some embodiments, a first user profile may be associated with user authentication credentials that enables the first user to authenticate themselves as associated with or otherwise having access to a service request and/or first user service response data object as defined hereafter. The first user device may be configured with one or more image devices (e.g., cameras, and/or the like). The one or more image devices may be positioned in a variety of location on the first user device (e.g., front, back, etc.) such that the one or more image devices may capture one or more fields of view. The first user device may be configured to generate image data associated with one or more users using the one or more image devices. In some embodiments, the first user device may be configured to capture multiple users using two or more image devices such that the multiple users may be captured in different fields of view at the same time.

As used herein, the term “second user device” refers to a user device as defined above that is associated with a second user which may be in network communication with the predictive data analysis system and designated user devices. For example, a second user device may be a computing device of a second user that may request, receive, and/or provide data to or from one of the devices described above. By way of a particular example, a second user device may be a mobile device associated with a second user and used to, in whole or in part, complete a service for the second user. Furthermore, a second user device and associated second user may include a second user profile. Such a second user profile may refer to electronically managed data representing the second user within a computing environment and may include data that embodies and/or uniquely identifies a user within the computing environment. In some embodiments, a second user profile may be associated with user authentication credentials that enables the second user to authenticate themselves as associated with or otherwise having access to a service request and/or second user service response data object as defined hereafter. The second user device may be configured with one or more image devices (e.g., cameras, and/or the like). The one or more image devices may be positioned in a variety of location on the first user device (e.g., front, back, etc.) such that the one or more image devices may capture one or more fields of view. The second user device may be configured to generate image data associated with one or more users using the one or more image devices. In some embodiments, the second user device may be configured to capture multiple users using two or more image devices such that the multiple users may be captured in different fields of view at the same time.

As used herein, the term “transaction payment request data object” may refer to a data construct that describes a request for performing services related to the transfer of funds related to a transaction, for example a request for withdrawal of funds from a user account of one or more payer users and depositing of funds into a user account of one or more payee users. In some embodiments, the transaction payment request data object includes image data generated by the user device that is indicative (e.g., includes captured depictions of) a plurality of users (e.g., one or more payer users, one or more payee users, and/or the like). In some embodiments, the transaction request data object includes a transaction payment request value, as further described below. In some embodiments, the transaction payment request data object includes metadata included as part of the image data (referred to herein as “metadata” or “image metadata”), such as metadata describing one or more identifying characteristics of at least one user and/or one or more identifying characteristics of the user device. In some embodiments, the metadata associated with the image data describes structured data associated with the user device and/or with at least one of the users depicted by the image data.

Examples of such structured data includes structured data describing identifying characteristics of the user device and/or identifying characteristics of at least one user depicted by the image data. In some embodiments, identifying characteristics of the user device (which may be described by the metadata associated with the image data) include at least one of a device identifier (e.g., a device Internet Protocol (IP) address), a device type identifier, a device location identifier (e.g., a device Geographic Positioning System (GPS) location identifier), a device operating system version identifier, a device camera hardware descriptor, a device camera software descriptor, an imaging device identifier (e.g., an imaging device identifier describing whether the imaging device used to capture an image in the image data is the front-facing camera of the user device or the rear-facing camera of the user device), and/or the like. In some embodiments, identifying characteristics of a user include at least one of an expected facial gesture of the user that is captured by the image data, an expected location of the user within an image in the image data, an expected field of view (FOV) of the image data that depicts visual data associated with the user, an imaging device identifier describing the imaging device used to capture the image of the user (e.g., an imaging device identifier describing whether the imaging device used to capture the user image is the front-facing camera of the user device or the rear-facing camera of the user device), and/or the like.

As used herein, the term “transaction payment request value” may refer to a data construct that describes a total value of a transaction associated with a set of users, for example a total amount of funds that should be withdrawn from the user accounts of a set of payer users and be deposited into the user accounts of a set of payee users. As such, in some embodiments, a transaction payment request data object describes a set of users (e.g., a set of payer users) using the image data of the transaction payment request data object, and then allocates a total value to the set of users via the transaction payment request value of the transaction payment request data object. Accordingly, in some embodiments, the image data of the transaction payment request data object is processed in accordance with various embodiments of the present disclosure to perform at least one of identifying the set of users, authenticating each user in the set of users, determining a sub-transaction amount for the set of users, or determining a sub-transaction value for each user in the set of users. In this way, various embodiments of the present disclosure introduce techniques for using image data for multi-user identification, authentication, and/or transaction allocation using at least some of the techniques described herein.

The term “sub-transaction value” may refer to a data construct that describes a portion of a transaction payment request value that is allocated to a corresponding user of the transaction payment request data object that is associated with the set of users for the transaction payment request data object. In some embodiments, given a set of users associated with the transaction payment request data object, each user is allocated a portion of the transaction payment request value associated with the transaction payment request data object. In some embodiments, each user is allocated an equal portion of the transaction payment request value associated with the transaction payment request data object, such that, for example, the first sub-transaction value for a first user and the second sub-transaction value for a second user are the same. In some embodiments, determining the sub-transaction value for a transaction payment request data object includes determining that a particular number of users are associated with the transaction payment request data object (e.g., based on the image data and/or the image metadata associated with the transaction payment request data object), dividing the transaction payment request value associated with the transaction payment request data object by n to generate a division output, where n equals the count of users associated with the transaction payment request data object, and/or allocating, to each of the users, a sub-transaction value equal to the division output. For example, if the transaction payment request value for a transaction payment request data object is $180.00, and if the transaction payment request data object is associated with three users, then each user may be allocated a sub-transaction value of $60.00.

The term “responsive transaction payment data object” may refer to a data construct that describes a transaction allocation of a transaction payment request value among a set of users associated with a corresponding transaction payment request data object. For example, in some embodiments, the responsive transaction data object requires, for each user, withdrawing an amount of funds equal to the sub-transaction value of the user from a user account of the user and depositing the amount of funds equal to the sub-transaction value to the user account of a payee. In some embodiments, given m users, where each ith user is associated with a respective sub-transaction value sᵢ, the responsive transaction data object contains instructions for withdrawing, from the user account of each ith user, an amount of funds equal to sp. Moreover, in some of the noted embodiments, the responsive transaction data object may contain instructions for depositing into the user account of a payee an amount of funds equal to Σᵢ^{m} sᵢ. In some embodiments, the responsive transaction payment data object is generated based on one or more supplementary user data objects, where the one or more supplementary user data objects are associated with the transaction payment request data object and/or the one or more supplementary user data objects includes image data depicting one or more additional users. In some embodiments, the one or more one or more supplementary user data objects are received from one or more additional user devices.

The term “supplementary user data object” may refer to a data construct that describes supplementary non-image data that may be used to automatically infer that a corresponding user is in an image. For example, if supplementary non-image location data associated with a user describes that the user is in a first location, and if the first location is associated with the image data and/or the image metadata, then the apparatus may automatically infer that the user is in the first image. As another example, if the supplementary non-image location data describes that a user is associated with a first user device, and if image metadata describes that a particular image is captured using the first user device, then the apparatus may automatically infer that the user is in the first image. In some embodiments, the apparatus may determine, using a user aggregation machine learning model, that the image data included in the one or more supplementary user data objects may be associated with the supplementary user data object based at least in part on a supplementary confidence score indicative of a likelihood that the one or more images are associated with the transaction payment request data object.

Having set forth a series of definitions called-upon throughout this application, an example system architecture and example apparatus is described below for implementing example embodiments and features of the present disclosure.

### Computer Program Products, Methods, and Computing Entities

Embodiments of the present disclosure may be implemented in various ways, including as computer program products that include articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that includes combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### Exemplary System Framework

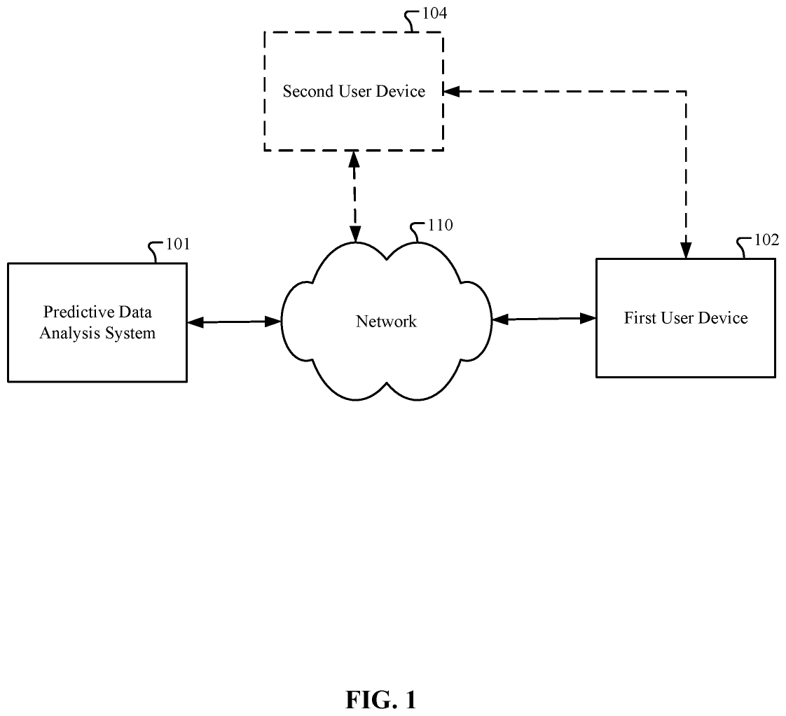

With reference to FIG. 1, an example system 100 is illustrated with an apparatus (e.g., a predictive data analysis system 101) communicably connected via a network 110 to a first user device 102 and, in some embodiments, a second user device 104. As shown, the first user device 102 may be communicably connected with the second user device 104.

The predictive data analysis system 101 may include circuitry, networked processors, or the like configured to perform some or all of the apparatus-based (e.g., predictive data analysis system-based) processes described herein, and may be any suitable network server and/or other type of processing device. In this regard, predictive data analysis system 101 may be embodied by any of a variety of devices. For example, the predictive data analysis system 101 may be configured to receive/transmit data and may include any of a variety of fixed terminals, such as a server, desktop, or kiosk, or it may include any of a variety of mobile terminals, such as a portable digital assistant (PDA), mobile telephone, smartphone, laptop computer, tablet computer, or in some embodiments, a peripheral device that connects to one or more fixed or mobile terminals.

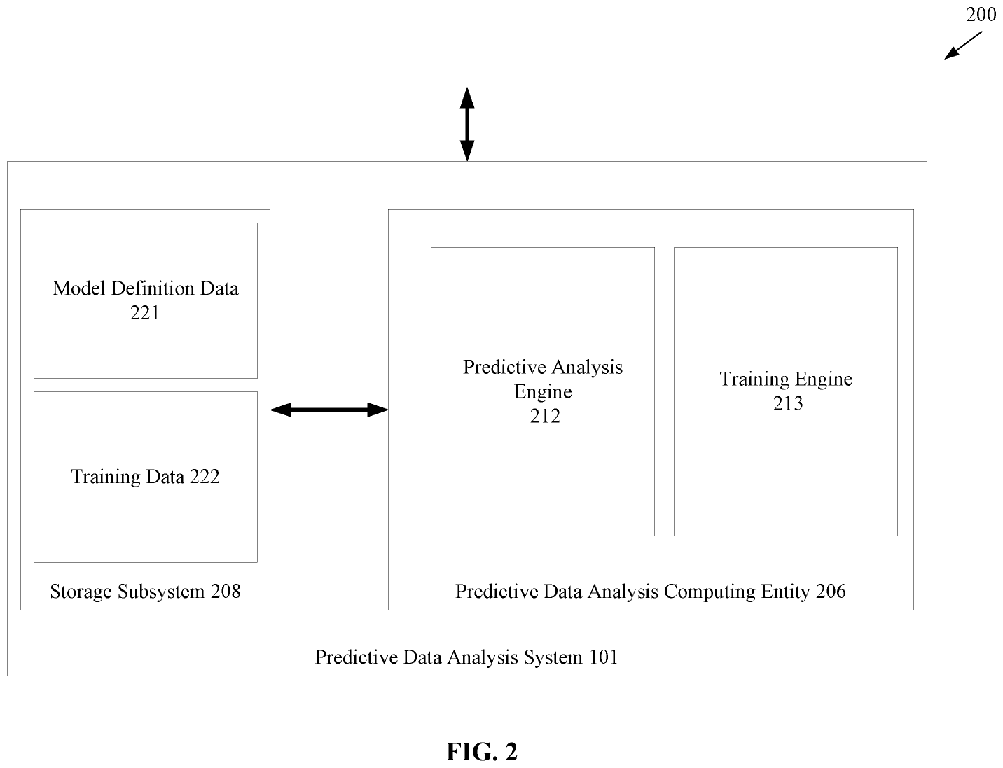

Example embodiments contemplated herein may have various form factors and designs but will nevertheless include at least the components illustrated in FIG. 2 and described in connection therewith. In some embodiments, the predictive data analysis system 101 may be located remotely from the first user device 102 and/or the second user device 104. In other embodiments, the predictive data analysis system 101 may include one or more of first user device 102 and/or second user device 104. Said differently, the present disclosure contemplates that each of the devices illustrated in FIG. 1 may perform operations that occur remotely from or locally to the predictive data analysis system 101. The predictive data analysis system 101 may, in some embodiments, include several servers or computing devices performing interconnected and/or distributed functions. Despite the many arrangements contemplated herein, the predictive data analysis system 101 is shown and described herein as a single computing device to avoid unnecessarily overcomplicating the disclosure.

The first user device 102 may refer to a user device associated with a first user as defined above and may be a cellular telephone (e.g., a smartphone and/or other type of mobile telephone), laptop, tablet, electronic reader, e-book device, media device, wearable, smart glasses, smartwatch, or any combination of the above. The first user device 102 may be configured to, for example, communicate with the predictive data analysis system 101 and provide a service request. Similarly, the second user device 104 may refer to a user device associated with a designated user as defined above and may also be a cellular telephone (e.g., a smartphone and/or other type of mobile telephone), laptop, tablet, electronic reader, e-book device, media device, wearable, smart glasses, smartwatch, or any combination of the above. Although described hereafter with reference to a first user device 102 and a second user device 104, the example system 100 may include any number of user devices associated with the same user or any number of respective other users.

FIG. 2 is a schematic diagram of an example system architecture 100 for performing predictive data analysis operations (e.g., selecting a designated user to fulfill a service request on behalf of the first user). The system architecture 200 includes a predictive data analysis system 101 comprising a predictive data analysis computing entity 206 configured to generate predictive outputs that can be used to perform one or more prediction-based actions. The predictive data analysis system 101 may communicate with one or more computing entities such as first user device 102 and/or a second user device 104 using one or more communication networks, such as network 110. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The system architecture 200 may include a storage subsystem 208 configured to store at least a portion of the data utilized by the predictive data analysis system 101. The predictive data analysis computing entity 206 may be in communication with one or more computing entities, such as first user device 102 and/or second user device 104 based at least in part on the training data store 222 stored in the storage subsystem 208, store trained prediction models as part of the model definition data store 221 stored in the storage subsystem 208, utilize trained models to generate an ordered list of designated users based at least in part on event request data and/or designated user parameter data that may be provided by an computing entity. The storage subsystem may be configured to store the model definition data store 221 for one or more predictive analysis models and the training data store 222 uses to train one or more predictive analysis models. The predictive data analysis computing entity 206 may be configured to receive requests and/or data from computing entities (e.g., first user device 102), process the requests and/or data to generate predictive outputs (e.g., a suitable designated user to fulfill a service request for the first user), and take actions based on the predictive outputs. The computing entity may periodically update/provide raw input data (e.g., service request data) to the predictive data analysis system 101. The computing entities may further generate user interface data (e.g., one or more data objects) corresponding to the received outputs and may provide (e.g., transmit, send and/or the like) the user interface data corresponding with the outputs for presentation to user computing entities operated by end-users (e.g., a first user and/or a designated user).

The storage subsystem 208 may be configured to store at least a portion of the data utilized by the predictive data analysis computing entity 206 to perform predictive data analysis steps/operations and tasks. The storage subsystem 208 may be configured to store at least a portion of operational data and/or operational configuration data including operational instructions and parameters utilized by the predictive data analysis computing entity 206 to perform predictive data analysis steps/operations in response to requests. The storage subsystem 208 may include one or more storage units, such as multiple distributed storage units that are connected through a computer network. Each storage unit in the storage subsystem 208 may store at least one of one or more data assets and/or one or more data about the computed properties of one or more data assets. Moreover, each storage unit in the storage subsystem 208 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The predictive data analysis computing entity 206 includes a predictive analysis engine 210 and a training engine 212. The predictive analysis engine 210 may be configured to perform predictive data analysis based at least in part on a received service request. The training engine 212 may be configured to train the predictive analysis engine 210 in accordance with the training data store 222 stored in the storage subsystem 208.

### Exemplary Predictive Data Analysis Computing Entity

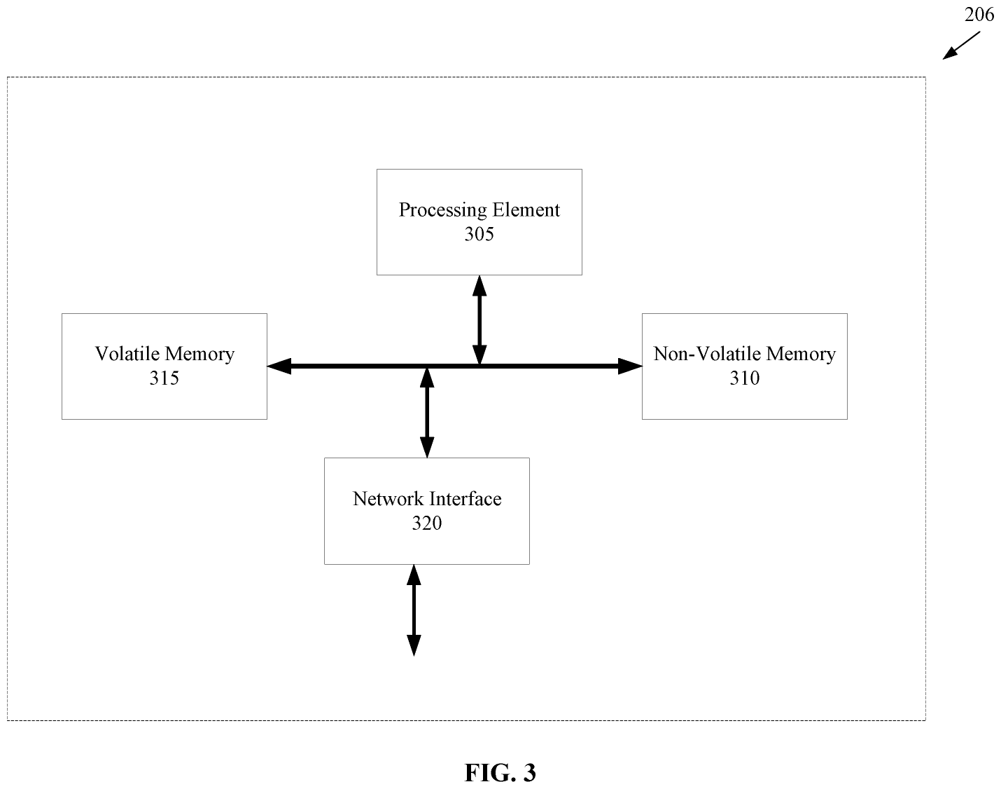

FIG. 3 provides a schematic of a predictive data analysis computing entity 206 according to one embodiment of the present disclosure. Additionally or alternatively, the schematic illustrated in FIG. 3 may also be apply to a first user device 102 and/or a second user device 104. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Such functions, steps/operations, and/or processes may include, for example, transmitting, receiving, operating on, processing, displaying, storing, determining, creating/generating, monitoring, evaluating, comparing, and/or similar terms used herein interchangeably. In one embodiment, these functions, steps/operations, and/or processes can be performed on data, content, information, and/or similar terms used herein interchangeably. Although described herein with respect to the predictive data analysis computing entity 206, it should be appreciated that any operations described below may be performed in whole or in part by predictive data analysis computing entity 206 and any other components of the predictive data analysis system 101 may perform the steps, operations, and/or functions.

As indicated, in one embodiment, the predictive data analysis computing entity 206 may also include a network interface 320 for communicating with various computing entities, such as by communicating data, content, information, and/or similar terms used herein interchangeably that can be transmitted, received, operated on, processed, displayed, stored, and/or the like.

As shown in FIG. 3, in one embodiment, the predictive data analysis computing entity 206 may include or be in communication with a processing element 305 (also referred to as processors, processing circuitry, and/or similar terms used herein interchangeably) that communicate with other elements within the predictive data analysis computing entity 206 via a bus, for example. As will be understood, the processing element 305 may be embodied in a number of different ways.

For example, the processing element 305 may be embodied as one or more complex programmable logic devices (CPLDs), microprocessors, multi-core processors, coprocessing entities, application-specific instruction-set processors (ASIPs), microcontrollers, and/or controllers. Further, the processing element 305 may be embodied as one or more other processing devices or circuitry. The term circuitry may refer to an entirely hardware embodiment or a combination of hardware and computer program products. Thus, the processing element 305 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 305 may be configured for a particular use or configured to execute instructions stored in volatile or non-volatile media or otherwise accessible to the processing element 305. As such, whether configured by hardware or computer program products, or by a combination thereof, the processing element 305 may be capable of performing steps or operations according to embodiments of the present disclosure when configured accordingly.

In one embodiment, the predictive data analysis computing entity 206 may further include or be in communication with non-volatile media (also referred to as non-volatile storage, memory, memory storage, memory circuitry and/or similar terms used herein interchangeably). In one embodiment, the non-volatile storage or memory may include at least one non-volatile memory 310, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 206 may further include or be in communication with volatile media (also referred to as volatile storage, memory, memory storage, memory circuitry and/or similar terms used herein interchangeably). In one embodiment, the volatile storage or memory may also include at least one volatile memory 315, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 305. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 206 with the assistance of the processing element 305 and operating system.

As indicated, in one embodiment, the predictive data analysis computing entity 206 may also include a network interface 320 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 206 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 206 may include or be in communication with one or more input elements, such as a keyboard input, a mouse input, a touch screen/display input, motion input, movement input, audio input, pointing device input, joystick input, keypad input, and/or the like. The predictive data analysis computing entity 206 may also include or be in communication with one or more output elements (not shown), such as audio output, video output, screen/display output, motion output, movement output, and/or the like.

### Example System Operations

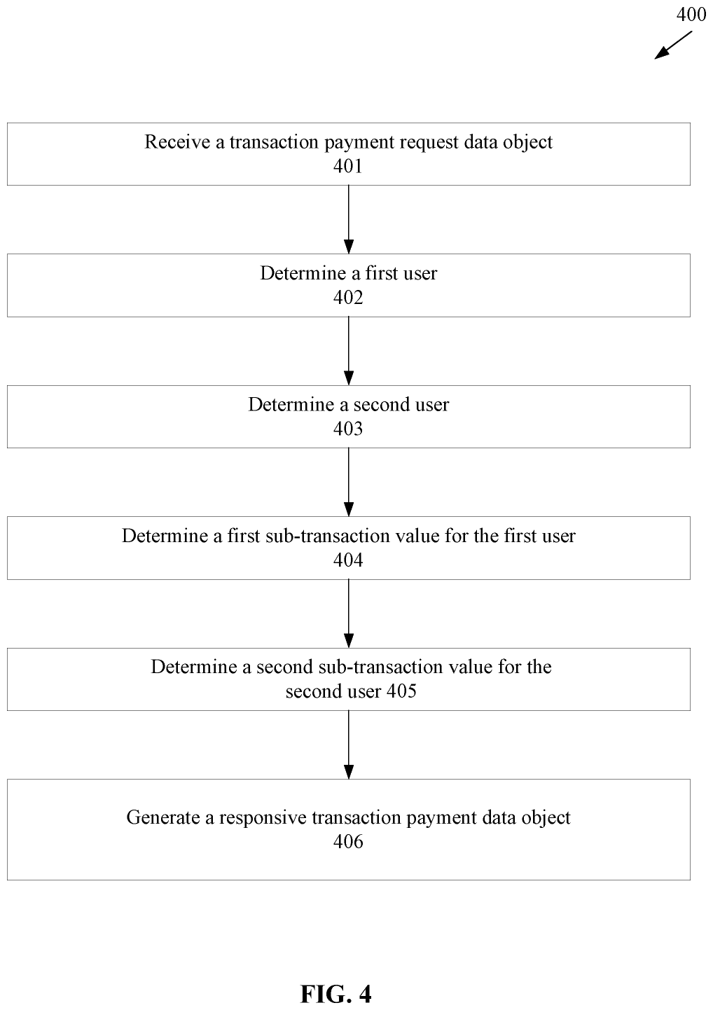

FIG. 4 illustrates a flowchart containing a series of operations of a process 400 for image-based transaction authentication and allocation across a plurality of users. The operations illustrated in FIG. 4 may, for example, be performed by, with the assistance of, and/or under the control of an apparatus (e.g., predictive data analysis system 101), as described above. In this regard, performance of the operations may invoke one or more of the processing element 305, non-volatile memory 310, volatile memory 210, and/or network interface 320. Although described herein with respect to the predictive data analysis computing entity 206, it should be appreciated that any operations described below may be performed in whole or in part by predictive data analysis computing entity 206 and any other components of the predictive data analysis system 101 may perform the below described steps, operations, and/or functions.

As shown in step/operation 401, the apparatus (e.g., predictive data analysis computing entity 206 of predictive data analysis system 101) includes means, such as network interface 320, or the like, for receiving a transaction payment request data object from a user device (e.g., from the first user device 102, from the second user device 104, and/or the like). While described operations may be described with respect to the first user device 102, it should be appreciated that in some embodiments, the operations may be performed with respect to the second user device 104. In some embodiments, the transaction payment request data object defines a request for performing services related to the transfer of funds related to a transaction, for example a request for withdrawal of funds from a user account of one or more payer users and depositing of funds into a user account of one or more payee users. In some embodiments, the transaction payment request data object includes image data generated by the first user device 102 that are indicative (e.g., includes captured depictions of) a plurality of users (e.g., one or more payer users, one or more payee users, and/or the like). In some embodiments, the transaction request data object includes a transaction payment request value, as further described below.

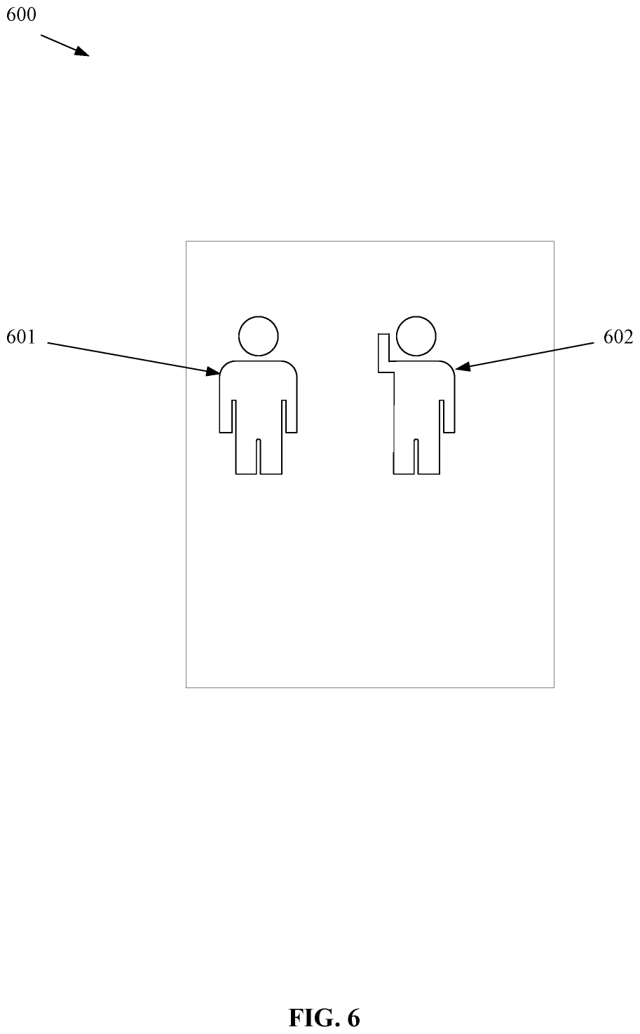

In some embodiments, the transaction payment request data object includes metadata included as part of the image data (referred to herein as “metadata” or “image metadata”), such as metadata describing one or more identifying characteristics of at least one user (such as a first user 601 and/or second user 602 as shown in FIG. 6) and/or one or more identifying characteristics of the first user device 102. In some embodiments, the metadata associated with the image data describes structured data associated with the first user device 102 and/or with at least one of the users, such as a first user 601, depicted by the image data. Examples of such structured data include structured data describing identifying characteristics of the first user device 102 and/or identifying characteristics of at least one user, such as a first user 601, depicted by the image data. In some embodiments, identifying characteristics of the first user device 102 (which may be described by the metadata associated with the image data) include at least one of a device identifier (e.g., a device Internet Protocol (IP) address), a device type identifier, a device location identifier (e.g., a device Geographic Positioning System (GPS) location identifier), a device operating system version identifier, a device camera hardware descriptor, a device camera software descriptor, an imaging device identifier (e.g., an imaging device identifier describing whether the imaging device used to capture an image in the image data is the front-facing camera of the user device or the rear-facing camera of the user device), and/or the like. In some embodiments, identifying characteristics of a first user 601 include at least one of an expected facial gesture of the user that is captured by the image data, an expected location of the user within an image in the image data, an expected field of view (FOV) of the image data that depicts visual data associated with the user, an imaging device identifier describing the imaging device used to capture the image of the user (e.g., an imaging device identifier describing whether the imaging device used to capture the user image is the front-facing camera of the user device or the rear-facing camera of the user device), and/or the like.

As described in greater detail below, in some embodiments, the image metadata of the transaction payment request data object may be used for identifying the users associated with the transaction payment request data object, authenticating at least one of the users associated with the transaction payment request data object, determining a sub-transaction amount for the users associated with the transaction payment request data object, and/or determining a sub-transaction value for at least one of the users associated with the transaction payment request data object.

In some embodiments, the transaction payment request data object includes a transaction payment request value. The transaction payment request value may describe a total value of a transaction associated with a set of users, such as first user 601 and/or second user 602, for example a total amount of funds that should be withdrawn from the user accounts of a set of payer users and be deposited into the user accounts of a set of payee users. As such, in some embodiments, a transaction payment request data object describes a set of users (e.g., a set of payer users such as first user 601 and/or second user 602) using the image data of the transaction payment request data object, and then allocates a total value to the set of users via the transaction payment request value of the transaction payment request data object. Accordingly, in some embodiments, the image data of the transaction payment request data object is processed in accordance with various embodiments of the present disclosure to perform identifying the set of users, authenticating each user in the set of users, determining a sub-transaction amount for the set of users, and/or determining a sub-transaction value for each user in the set of users. In this way, various embodiments of the present disclosure introduce techniques for using image data for multi-user identification, authentication, and/or transaction allocation using at least some of the techniques described herein.

An operational example of an image 600 that may be associated with a transaction payment request data object is depicted in FIG. 6. As depicted in FIG. 6, the image 600 includes depictions of two users, a first user 601 and second user 602. As further depicted in FIG. 6, the second user 602 has a body gesture associated with raising hands. In some embodiments, the second user 602 may adopt the noted body gesture based on instructions provided by a software application operating on the first user device 102 that captures image data associated with the transaction payment request data object and transmits the image data to the apparatus.

Returning now to FIG. 4, as shown in step/operation 402, the apparatus (e.g., predictive data analysis computing entity 206 of predictive data analysis system 101) includes means, such as processing element 305, network interface 320, or the like, for determining a first user based on the image data. In some embodiments, the apparatus processes at least one of the images or the image metadata of the image data in order to determine each user of a set of users, including a first user 601 and a second user 602.

In some embodiments, the images of both the first user 601 and the second user 601 are generated by a common imaging device of the first user device 102. For example, the images of both users 601 and 602 may be generated by a front-facing camera device of the first user device 102. As another example, the images of both users 601 and 602 may be generated by a rear-facing camera of the first user device 102. In some embodiments, the image of a first user 601 is captured by a first imaging device of the first user device 601 while the image of a second user 602 is captured by a second imaging device of the first user device 602. For example, the image of the first user 601 may be generated by a front-facing camera device of the first user device 102, while the image of the second user 602 may be generated by a rear-facing camera device of the first user device 102. As another example, the image of the first user 601 may be generated by a rear-facing camera device of the first user device 102, while the image of the second user 602 may be generated by a front-facing camera device of the first user device 102.

In some embodiments, depictions of both users 601 and 602 are captured with a common image, while in other embodiments a first image depicts the first user 601 and a second image depicts the second user 602 (where the first image and the second image may be captured by the same or different imaging devices, and where the first image and the second image may be captured using the same or different FOVs). In some embodiments, even when depictions of both users 601 and 602 are captured with a common image, the two users are located in different regions of an image frame of the image, while in other embodiments the first user 601 and the second user 602 are commonly located within the same image region of an image frame included in the image data. As described above, the image metadata may describe such identifying characteristics of the image data, such as (for example), for each user in a set of users associated with the transaction payment request data object, the imaging device used to capture an image of user, image identifiers for particular images that contain depictions of the user, the image region of an image that contains depictions of the user, the FOV of particular images that contain depictions of the user, and/or the like.

In some embodiments, to determine a particular user (e.g., either first user 601 or second user 602), the apparatus identifies a plurality of users associated with the image data. This may include retrieving image data describing the plurality of users (i.e., first user 601 and second user 602) depicted by the image data, for example via a plurality of user identifiers and/or a plurality of user profile identifiers for the plurality of users. In some embodiments, identifying a plurality of users includes processing the image data using a facial recognition machine learning model to detect one or more faces depicted by the image data, and mapping each detected face to a user in a set of users associated with the apparatus by processing the detected face using a facial image classification machine learning model.

In some embodiments, to identify the plurality of users, the apparatus may retrieve image metadata describing that a particular region of a particular image includes the image of a user and processes the particular region using a facial image classification machine learning model to determine a user associated with the particular image. In some embodiments, the noted steps may be repeated for each combination of image regions that are collectively described by the image metadata to describe a common user. For example, in some embodiments, the image metadata for one image associated with four image regions may describe that a first image region depicts one user (e.g., first user 601), a second image region depicts another user (e.g., a second user 602), a third image region depicts a yet another user (e.g., a third user), and a fourth image region depicts an additional user (e.g., a fourth user). In this example, after processing the noted four images using the facial image classification machine learning model, the apparatus may determine the identity of the first user 601 associated with the first image region as described by the output of processing the first image region using the facial image classification machine learning model, the second user 602 associated with the second image region as described by the output of processing the second image region using the facial image classification machine learning model, the third user associated with the third image region as described by the output of processing the third image region using the facial image classification machine learning model, and the fourth user associated with the fourth image region as described by the output of processing the fourth image region using the facial image classification machine learning model.

In some embodiments, to identify a plurality of users, the apparatus performs identification of the number of users depicted by the image as described by the image metadata, processing of the images using a facial recognition machine learning model to detect n faces, where n corresponds to the identified number of users, and processing the n detected faces to map them to n users. For example, in some embodiments, the image metadata for a particular image may describe that a first image (e.g., a first image captured by a front-facing camera device) includes the image of a first user 601 while a second image (e.g., a second image captured by a rear-facing camera device) includes the image of a second user 602 and a third user. In this example, the apparatus may process the first image to determine a first user 601 and may process the second image to determine a second user 602 and a third user. As described above, in some embodiments, two or more users may be commonly located within an image frame of an image. In some of the noted embodiments, the image frame is processed (e.g., using a facial recognition machine learning model) to detect two or more faces, and then the two or more faces are mapped (e.g., using a facial image classification machine learning model) to the two or more users.

In some embodiments, determining a user (e.g., determining the first user 601) includes authenticating the first user 601. In some embodiments, authenticating the first user 601 includes comparing one or more identifying characteristics of the first user 601 as determined based on the image data and/or the image metadata and one or more authenticating characteristics of the first user 601 as stored in a corresponding user profile of the first user 601. For example, in some embodiments, the one or more authenticating characteristics of the first user 601, as described by the corresponding user profile of the first user 601, may describe one or more facial expressions/gestures associated with the first user 601. In some of the noted embodiments, image data associated with a facial region of the first user 601 may be processed by a facial expression detection machine learning model to detect an identifying characteristic describing an inferred facial expression of the first user 601. In some of the noted embodiments, if the inferred facial expression of the first user 601 matches an authenticating facial expression of the first user 601 as described by the authenticating characteristics of the first user 601, then the first user 601 is authenticated. Otherwise, if the inferred facial expression of the first user 601 fails to match an authenticating facial expression of the first user 601 as described by the authenticating characteristics of the first user 601, then the first user 601 is not authenticated.

As another example, in some embodiments, the one or more authenticating characteristics of the first user 601, as described by the corresponding user profile of the user, may describe one or more body gestures (e.g., depicted finger sign) of the first user 601. In some of the noted embodiments, image data associated with a body region of the first user 601 may be processed by a body gesture detection machine learning model to detect an identifying characteristic describing an inferred body gesture of the first user 601. In some of the noted embodiments, if the inferred body gesture of the first user 601 matches an authenticating body gesture of the first user 601 as described by the authenticating characteristics of the user, then the first user 601 is authenticated. Otherwise, if the inferred body gesture of the first user 601 fails to match an authenticating body gesture of the first user 601 as described by the authenticating characteristics of the user, then the first user 601 is not authenticated.

As shown in step/operation 403, the apparatus (e.g., predictive data analysis computing entity 206 of predictive data analysis system 101) includes means, such as network interface 320, or the like, for determining a second user 602. In some embodiments, the techniques described in relation to step/operation 402 can be used to detect any number of users, including a first user 601, a second user 602, and/or the like. Accordingly, in some embodiments, determining a second user 602 uses the same general operations as those used to determine a first user 601, but instead uses image data and/or image metadata associated with the second user 602 instead of the first user 601.

As shown in step/operation 404, the apparatus (e.g., predictive data analysis computing entity 206 of predictive data analysis system 101) includes means, such as network interface 320, or the like, for determining a first sub-transaction value for the first user 601. In some embodiments, a sub-transaction value describes a portion of a transaction payment request value that is allocated to a corresponding user (i.e., first user 601) of the transaction payment request data object that is associated with the set of users (i.e., first user 601 and second user 602) for the transaction payment request data object. In some embodiments, given a set of users associated with the transaction payment request data object, each user is allocated a portion of the transaction payment request value associated with the transaction payment request data object. In some embodiments, each user is allocated an equal portion of the transaction payment request value associated with the transaction payment request data object, such that (for example) the first sub-transaction value for a first user 601 and second sub-transaction value for a second user 602 are the same.

In some embodiments, determining the sub-transaction value for a transaction payment request data object includes determining that a particular number of users are associated with the transaction payment request data object (e.g., based on the image data and/or the image metadata associated with the transaction payment request data object), dividing the transaction payment request value associated with the transaction payment request data object by n to generate a division output, where n equals the count of users associated with the transaction payment request data object, and allocating, to each of the users, a sub-transaction value equal to the division output. For example, if the transaction payment request value for a transaction payment request data object is $180.00, and if the transaction payment request data object is associated with three users, then each user may be allocated a sub-transaction value of $60.00.

In some embodiments, determining the sub-transaction value for a transaction payment request data object includes identifying a plurality of users associated with the transaction payment request data object (e.g., based on the image data and/or the image metadata associated with the transaction payment request data object). The transaction payment request data object may also include, for each user, determining one or more identifying characteristics (e.g., based on the image data and/or the image metadata associated with the transaction payment request data object). The transaction payment request data object may also include, for each user, determining a sub-transaction value based on the one or more identifying characteristics associated with the user. For example, configuration data associated with the apparatus may describe that the first user 601 having a first facial expression is associated with ⅓ of the transaction payment request value, while the second user 602 having a second facial expression is associated with ⅔ of the transaction payment request value. In such an embodiment, if the identifying characteristics of the first user 601 (e.g., as determined based on the image data and/or the image metadata associated with the transaction payment request data object) describe that the first user 601 is associated with the first facial expression, and further if the identifying characteristics of the second user 602 (e.g., as determined based on the image data and/or the image metadata associated with the transaction payment request data object) describe that the second user 602 is associated with the second facial expression, and further if the transaction payment request value is $180.00, then the first user 601 may be associated with the first sub-transaction value of $60.00 and the second user 602 may be associated with the second sub-transaction value of $120.00.

As another example, configuration data associated with the apparatus may describe that the user whose image is captured using a front-facing camera device (i.e., first user 601) is associated with ⅓ of the transaction payment request value, while the user whose image is captured using a rear-facing camera device (i.e., second user 602) is associated with ⅔ of the transaction payment request value. In some embodiments, if the identifying characteristics of the first user 601 (e.g., as determined based on the image data and/or the image metadata associated with the transaction payment request data object) describe that the image captured by the front-facing camera device depicts the first user 601, and further if the identifying characteristics of the second user 602 (e.g., as determined based on the image data and/or the image metadata associated with the transaction payment request data object) describe that the image captured by the rear-facing camera device depicts the second user 602, and further if the transaction payment request value is $180.00, then the first user 601 may be associated with the first sub-transaction value of $60.00 and the second user 602 may be associated with the second sub-transaction value of $120.00.

As an additional example, configuration data associated with the apparatus may describe that the user associated with a first image (i.e., first user 601) is allocated ⅓ of the transaction payment request value, while the user associated with a second image (i.e., second user 602) is allocated ⅔ of the transaction payment request value. In some embodiments, if the identifying characteristics of the first user 601 (e.g., as determined based on the image data and/or the image metadata associated with the transaction payment request data object) describe that the first user's 601 face is detected within the first image, and further if the identifying characteristics of the second user 602 (e.g., as determined based on the image data and/or the image metadata associated with the transaction payment request data object) describe that the second user's 602 face is detected within the first image, and further if the transaction payment request value is $180.00, then the first user 601 may be associated with the first sub-transaction value of $60.00 and the second user 602 may be associated with the second sub-transaction value of $120.00.

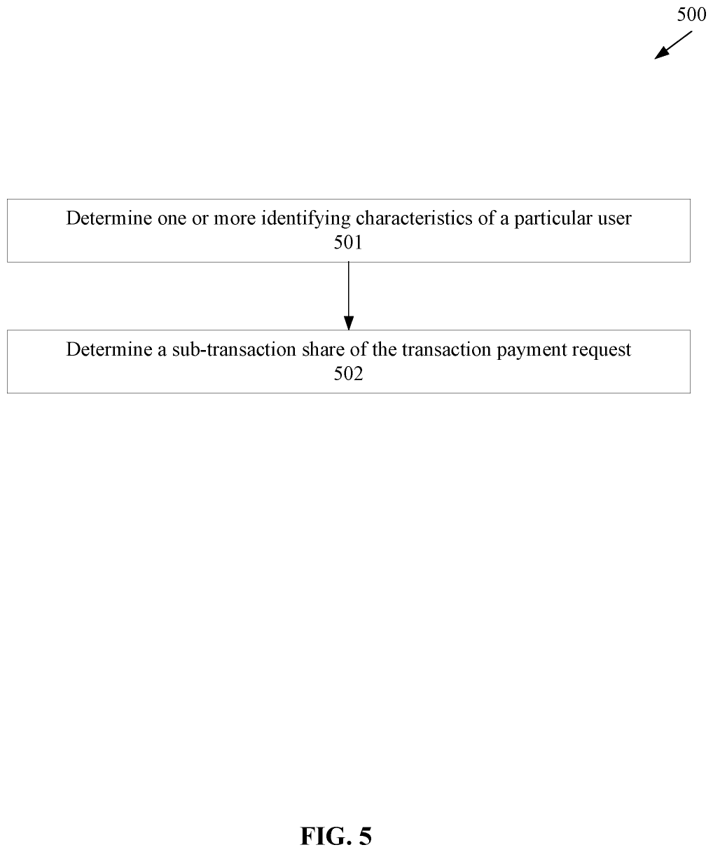

In some embodiments, step/operation 404 may be performed in accordance with the process 500 that is depicted in FIG. 5, which is an example process for determining a sub-transaction value for a particular user (e.g., for the first user 601, for the second user 602, and/or the like).

As shown in step/operation 501, the apparatus (e.g., predictive data analysis computing entity 206 of predictive data analysis system 101) includes means, such as processing element 305, network interface 320, or the like, for determining one or more identifying characteristics of the particular user. As described above, identifying characteristics of a user include at least one of an expected facial gesture of the user that is captured by the image data, an expected location of the user within an image in the image data, an expected field of view (FOV) of the image data that depicts visual data associated with the user, an imaging device identifier describing the imaging device used to capture the image of the user (e.g., an imaging device identifier describing whether the imaging device used to capture the user image is the front-facing camera of the user device or the rear-facing camera of the user device), and/or the like.

As shown in step/operation 502, the apparatus (e.g., predictive data analysis computing entity 206 of predictive data analysis system 101) includes means, such as processing element 305, network interface 320, or the like, for determining, based on the identifying characteristics, a sub-transaction share of the transaction payment request value for the particular user profile. In some embodiments, the identifying characteristics of the particular user are mapped to a particular sub-transaction share based on configuration data associated with the apparatus. For example, in an some embodiments, configuration data associated with the apparatus may describe that the first user 601 having a first facial expression is associated with ⅓ of the transaction payment request value, while the second user 602 having a second facial expression is associated with ⅔ of the transaction payment request value. As another example, in another embodiment, configuration data associated with the apparatus may describe that the first user 601 whose image is captured using a front-facing camera device is associated with ⅓ of the transaction payment request value, while the second user 602 whose image is captured using a rear-facing camera device is associated with ⅔ of the transaction payment request value. As an additional example, in an additional embodiment, configuration data associated with the apparatus may describe that the first user 601 associated with a first image is allocated ⅓ of the transaction payment request value, while the second user 602 associated with a second image is allocated ⅔ of the transaction payment request value.

As shown in step/operation 502, the apparatus (e.g., predictive data analysis computing entity 206 of predictive data analysis system 101) includes means, such as processing element 305, network interface 320, or the like, for determining the sub-transaction value for the particular user based on the sub-transaction share for the particular user and the transaction payment request value. For example, if the transaction payment request value is $180.00, and if the sub-transaction share for the first user 601 is ⅓ and the sub-transaction share for the second user 602 is ⅔, then the first user 601 may be associated with the first sub-transaction value of $60.00 and the second user 602 may be associated with the second sub-transaction value of $120.00.

Returning now to FIG. 4, as shown in step/operation 405, the apparatus (e.g., predictive data analysis computing entity 206 of predictive data analysis system 101) includes means, such as network interface 320, or the like, for determining a second sub-transaction value for second user 602. In some embodiments, the techniques described in relation to step/operation 404 can be used to detect sub-transaction values for any number of users, including a first user 601, a second user 602, and/or the like. Accordingly, in some embodiments, determining a second sub-transaction value for a second user 602 uses the same general operations as those used to determine a first sub-transaction value for a first user 601, but instead uses image data, image metadata, and/or identifying characteristics associated with the second user 602 instead of the first user 601.

As shown in step/operation 406, the apparatus (e.g., predictive data analysis computing entity 206 of predictive data analysis system 101) includes means, such as network interface 320, or the like, for generating a responsive transaction payment data object. In some embodiments, the responsive transaction data object describes a transaction allocation of a transaction payment request value among a set of users (i.e., first user 601 and second user 602) associated with a corresponding transaction payment request data object. For example, in some embodiments, the responsive transaction data object requires, for each user, withdrawing an amount of funds equal to the sub-transaction value of the user from user account of the user and depositing the amount of funds equal to the sub-transaction value to the user account of a payee. In some embodiments, given m users, where each ith user is associated with a respective sub-transaction value sᵢ, the responsive transaction data object contains instructions for withdrawing, from the user account of each ith user, an amount of funds equal to sᵢ. Moreover, in some of the noted embodiments, the responsive transaction data object may contain instructions for depositing into the user account of a payee an amount of funds equal to Σᵢ^{m} sᵢ.

In some embodiments, the responsive transaction payment data object is generated based on one or more supplementary user data objects. The one or more supplementary user data objects are associated with the transaction payment request data object and the one or more supplementary user data objects includes image data depicting one or more additional users. In some embodiments, the one or more one or more supplementary user data objects are received from one or more additional user devices, such as second user device 104.

In some embodiments, a supplementary user data object describes supplementary non-image data that can be used to automatically infer that a corresponding user is in an image. For example, if supplementary non-image location data associated with a user describes that the user is in a first location, and if the first location is associated with the image data and/or the image metadata, then the apparatus may automatically infer that the user is in the first image. As another example, if the supplementary non-image location data describes that a user is associated with a first user device 102, and if image metadata describes that a particular image is captured using the first user device 102, then the apparatus may automatically infer that the user is in the first image. In some embodiments, the apparatus may determine, using a user aggregation machine learning model, that the image data included in the one or more supplementary user data objects are associated with the supplementary user data object based at least in part on a supplementary confidence score indicative of a likelihood that the one or more images are associated with the transaction payment request data object.

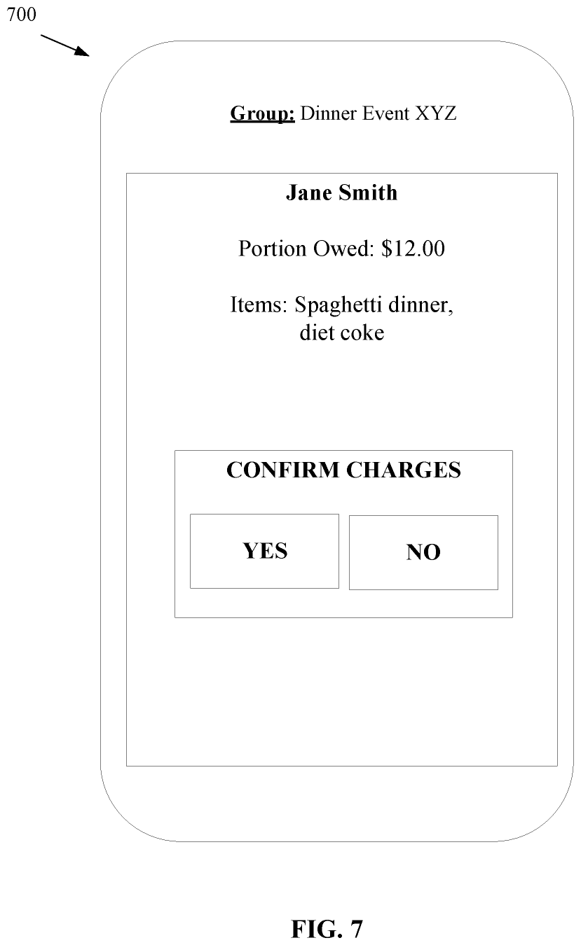

In some embodiments, once generated, the responsive transaction payment data object can be used to generate one or more user notifications on the user devices (e.g., first user device 102 and/or second user device 104) that request authorization for transfer of funds equal to the sub-transaction values for the corresponding users. An operational example of such a user notification 700 is depicted in FIG. 7. As depicted in FIG. 7, the user notification 700 is a request for authorization of transfer of $12.00, which may be determined based on the sub-transaction value for the corresponding first user (i.e., for Jane Smith) based on the transaction payment request data object for the dinner event at the XYZ restaurant. The first user 601 may use the user notification 700 to confirm or reject the noted request for authorization.

In some embodiments, the process 500 can be used to facilitate operations of a payment authentication system (PAS) for payment transactions using single authentication as an alternative to one-time passwords (OTPs) or the like. The PAS may authenticate a payer and payee using authentication information as received from one or more user devices by comparing the received authentication information to predetermined authentication data. Authentication information may include a facial image, facial gesture, and/or video of the individual. The PAS may automatically retrieve account details of the payer and payee and perform the financial transaction by debiting a default payer account and crediting a default account of the payee in an instance in which the payer and payee are authenticated.

The PAS may receive a transaction request from a payer or payee and activate one or more sensors of a user device associated with the requesting user (e.g., payer or payee) to capture authentication data (e.g., facial image, facial gesture, video, etc.) of the payer and/or payee. The PAS may compare the captured authentication data to predetermined authentication data, such as facial image data corresponding to the requesting user's profile to authenticate the transaction request. In an instance in which the transaction request is successfully authenticated, the PAS may retrieve account details of the requesting user and perform the financial transaction. In some instances, the sensors may simultaneously capture images/video of the payer and the payee, such as via a front facing camera and a rear facing camera of a user's device.

The PAS may additionally or alternatively capture authentication data of a group of individuals, including one or more payers and the payee, in response to the transaction request. The PAS may then authenticate the group of payers and the payee by comparing the captured authentication data to predetermined authenticated data, such as facial image data corresponding to each payer's profile to authenticate the transaction request. In some embodiments, the group of individuals may be required to exist in a common reference frame (e.g., a group photo) with different users required to provide different positions, expressions, etc. for authentication and/or modifications of the same in response to instructions by an associated device. When the transaction request is successfully authenticated, the PAS may retrieve account details of the group of payers and payee and perform the financial transaction by debiting a shared amount from the default accounts of the group of payers and crediting a total shared amount of each of the group of payers to the default account of the payee.

### CONCLUSION

Many modifications and other embodiments of the disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

The invention claimed is:

1. A computer-implemented method comprising:
receiving a transaction payment request data object from a first user device comprising one or more imaging devices, wherein the transaction payment request data object comprises:
image data associated with a plurality of users, wherein the image data includes a captured depiction of the plurality of users, and
a transaction payment request value;
identifying at least a first user and a second user from amongst the plurality of users based at least in part upon the image data, wherein identifying the first user and the second user comprises:
detecting, using a facial recognition machine learning model and based on the image data, a first face and a second face;
mapping, using a facial image classification machine learning model, the first face to the first user and the second face to the second user;
inferring, using a body gesture detection machine learning model, a first body gesture of the first user based on the image data and the first face mapped to the first user and a second body gesture of the second user based on the image data and the second face mapped to the second user;
comparing, using the body gesture detection machine learning model, the first body gesture of the first user to a first authenticating body gesture of the first user and the second body gesture of the second user to a second authenticating body gesture of the second user respectively; and
authenticating, using the body gesture detection machine learning model, the first user and the second user based on a respective comparison of the first body gesture of the first user to the first authenticating body gesture of the first user and the second body gesture of the second user to the second authenticating body gesture of the second user;
determining a first sub-transaction value for the first user, wherein the first sub-transaction value for the first user defines a first portion of the transaction payment request value of the transaction payment request data object;
determining a second sub-transaction value for the second user, wherein the second sub-transaction value for the second user defines a second portion of the transaction payment request value of the transaction payment request data object; and
generating a responsive transaction payment data object, wherein the responsive transaction payment data object comprises instructions for executing a transaction responsive to the transaction payment request data object.

2. The computer-implemented method of claim 1, wherein the image data comprises metadata including one or more identifying characteristics of at least one of the first user, the second user, or the first user device.

3. The computer-implemented method of claim 2, wherein the one or more identifying characteristics include a transaction allocation between the transaction payment request value and at least one of the first sub-transaction value or the second sub-transaction value.

4. The computer-implemented method of claim 2, further comprising authenticating the first user or the second user based at least in part on a comparison between the one or more identifying characteristics from the image data or image metadata and one or more authentication characteristics stored in a corresponding user profile.

5. The computer-implemented method of claim 1, wherein the first sub-transaction value and the second sub-transaction value each define an equal portion of the transaction payment request value.

6. The computer-implemented method of claim 1, further comprising:
generating the image data via a first imaging device of the one or more imaging devices of the first user device, and
wherein the first user and the second user are commonly located within an image frame of the image data.

7. The computer-implemented method of claim 1, wherein the image data comprises first image data and second image data, and wherein the computer-implemented method further comprises:
generating first image data via a first imaging device of the one or more imaging devices of the first user device at a first time that includes the first user, wherein the first imaging device is associated with a first field of view; and
generating second image data via a second imaging device of the one or more imaging devices of the first user device at the first time that includes the second user, wherein the second imaging device is associated with a second field of view.

8. The computer-implemented method of claim 1, further comprising:
receiving one or more supplementary user data objects, wherein (i) the one or more supplementary user data objects are associated with the transaction payment request data object and (ii) the one or more supplementary user data objects comprise image data depicting one or more additional users; and
generating the responsive transaction payment data object based at least in part on the one or more supplementary user data objects.

9. The computer-implemented method of claim 8, wherein the one or more supplementary user data objects are received from one or more additional user devices.

10. The computer-implemented method of claim 8, further comprising:
determining, using a user aggregation machine learning model, that the image data included in the one or more supplementary user data objects is associated with the one or more supplementary user data objects based at least in part on a supplementary confidence score associated with a likelihood that the image data is associated with the transaction payment request data object.

11. An apparatus comprising at least one processor and at least one memory, the at least one memory storing instructions that, when executed by the at least one processor, cause the at least one processor to perform operations including:
receiving a transaction payment request data object from a first user device comprising one or more imaging devices, wherein the transaction payment request data object comprises:
image data associated with a plurality of users, wherein the image data includes a captured depiction of the plurality of users, and
a transaction payment request value;
identifying at least a first user and a second user from amongst the plurality of users based at least in part upon the image data, wherein identifying the first user and the second user comprises:
detecting, using a facial recognition machine learning model and based on the image data, a first face and a second face;
mapping, using a facial image classification machine learning model, the first face to the first user and the second face to the second user;
inferring, using a body gesture detection machine learning model, a first body gesture of the first user based on the image data and the first face mapped to the first user and a second body gesture of the second user based on the image data and the second face mapped to the second user;
comparing, using the body gesture detection machine learning model, the first body gesture of the first user to a first authenticating body gesture of the first user and the second body gesture of the second user to a second authenticating body gesture of the second user respectively; and
authenticating, using the body gesture detection machine learning model, the first user and the second user based on a respective comparison of the first body gesture of the first user to the first authenticating body gesture of the first user and the second body gesture of the second user to the second authenticating body gesture of the second user;
determining a first sub-transaction value for the first user, wherein the first sub-transaction value for the first user defines a first portion of the transaction payment request value of the transaction payment request data object;
determining a second sub-transaction value for the second user, wherein the second sub-transaction value for the second user defines a second portion of the transaction payment request value of the transaction payment request data object; and
generating a responsive transaction payment data object, wherein the responsive transaction payment data object comprises instructions for executing a transaction responsive to the transaction payment request data object.

12. The apparatus of claim 11, wherein:
the image data includes metadata comprising one or more identifying characteristics of at least one of the first user, the second user, or the first user device.

13. The apparatus of claim 12, wherein the one or more identifying characteristics include a transaction allocation between the transaction payment request value and at least one of the first sub-transaction value or the second sub-transaction value.

14. The apparatus of claim 12, wherein the at least one memory stores further instructions that, when executed by the at least one processor, cause the at least one processor to perform operations including:
authenticating the first user or the second user based at least in part on a comparison between the one or more identifying characteristics from the image data or image metadata and one or more authentication characteristics stored in a corresponding user profile.

15. The apparatus of claim 11, wherein the first sub-transaction value and the second sub-transaction value each define an equal portion of the transaction payment request value.

16. A computer program product comprising at least one non-transitory computer-readable storage medium having computer-readable program code stored therein, wherein the computer-readable program code, when executed by at least one processor, causes the at least one processor to perform operations comprising:
receiving a transaction payment request data object from a first user device comprising one or more imaging devices, wherein the transaction payment request data object comprises:
image data associated with a plurality of users, wherein the image data includes a captured depiction of the plurality of users, and
a transaction payment request value;
identifying at least a first user and a second user from amongst the plurality of users based at least in part upon the image data, wherein identifying the first user and the second user comprises:
detecting, using a facial recognition machine learning model and based on the image data, a first face and a second face;
mapping, using a facial image classification machine learning model, the first face to the first user and the second face to the second user;
inferring, using a body gesture detection machine learning model, a first body gesture of the first user based on the image data and the first face mapped to the first user and a second body gesture of the second user based on the image data and the second face mapped to the second user;
comparing, using the body gesture detection machine learning model, the first body gesture of the first user to a first authenticating body gesture of the first user and the second body gesture of the second user to a second authenticating body gesture of the second user respectively; and
authenticating, using the body gesture detection machine learning model, the first user and the second user based on a respective comparison of the first body gesture of the first user to the first authenticating body gesture of the first user and the second body gesture of the second user to the second authenticating body gesture of the second user;
determining a first sub-transaction value for the first user, wherein the first sub-transaction value for the first user defines a first portion of the transaction payment request value of the transaction payment request data object;
determining a second sub-transaction value for the second user, wherein the second sub-transaction value for the second user defines a second portion of the transaction payment request value of the transaction payment request data object; and
generating a responsive transaction payment data object, wherein the responsive transaction payment data object comprises instructions for executing a transaction responsive to the transaction payment request data object.

17. The computer program product of claim 16, wherein:
the image data includes metadata comprising one or more identifying characteristics of at least one of the first user, the second user, or the first user device.

18. The computer program product of claim 17, wherein the one or more identifying characteristics include a transaction allocation between the transaction payment request value and at least one of the first sub-transaction value or the second sub-transaction value.

19. The computer program product of claim 17, wherein the computer-readable program code, when executed by the at least one processor, further causes the at least one processor to perform operations comprising:
authenticating the first user or the second user based at least in part on a comparison between the one or more identifying characteristics from the image data or image metadata and one or more authentication characteristics stored in a corresponding user profile.

20. (canceled)

21. The computer-implemented method of claim 7, wherein the second image data generated by the second imaging device of the one or more imaging devices of the first user device at the first time is generated simultaneously with the first image data generated by the first imaging device of the one or more imaging devices.
